(19) United States
(12) Patent Application Publication
(10) Pub. No.: US 2026/0222296 A1
(43) Pub. Date: Jul. 30, 2026

(54) REMOTE STATUS INDICATORS FOR PLUGGABLE DEVICE

(71) Applicant: Verizon Patent and Licensing Inc., Basking Ridge, NJ (US)

(72) Inventors: Sankar Subramanian, Ossining, NY (US); Terence R Brogan, Norton, MA (US); Robert W Stewart, Pleasant, NJ (US); Carlos J Borlando, Lansdale, PA (US); Amrit Bamzai, Livingston, NJ (US); Angelo Campos, Basking Ridge, NJ (US); Aaron R Orwasher, New York, NY (US)

(21) Appl. No.: 19/036,111

(22) Filed: Jan. 24, 2025

(51) Int. Cl. H04L 41/0893; H04L 41/0806; H04L 43/0811

(52) U.S. Cl. CPC H04L 41/0893; H04L 41/0806; H04L 43/0811

(57) ABSTRACT

According to some embodiments, a method includes executing an initialization process of a network communication device, evaluating a role parameter associated with the network communication device, and responsive to the role parameter corresponding to an automatic configuration condition, evaluating network connectivity on a communication interface of the network communication device, assigning a role to the network communication device based on the network connectivity, and configuring the network communication device according to the role during the initialization process.

### BACKGROUND

Network communication devices provide interconnections between different types of networks. For example, a passive optical network (PON) or a cellular network are examples of networks that provide a wide area network (WAN) connectivity for a premises device that implements a local area network (LAN).

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a communication system, according to some embodiments.

FIG. 2 is a block diagram of a network communication device, according to some embodiments.

FIG. 3 is a flow diagram illustrating an example method for configuring a network configuration device, according to some embodiments.

FIG. 4 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts.Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

According to some embodiments, a method includes executing an initialization process of a network communication device, evaluating a role parameter associated with the network communication device, and responsive to the role parameter corresponding to an automatic configuration condition, evaluating network connectivity on a communication interface of the network communication device, assigning a role to the network communication device based on the network connectivity, and configuring the network communication device according to the role during the initialization process.

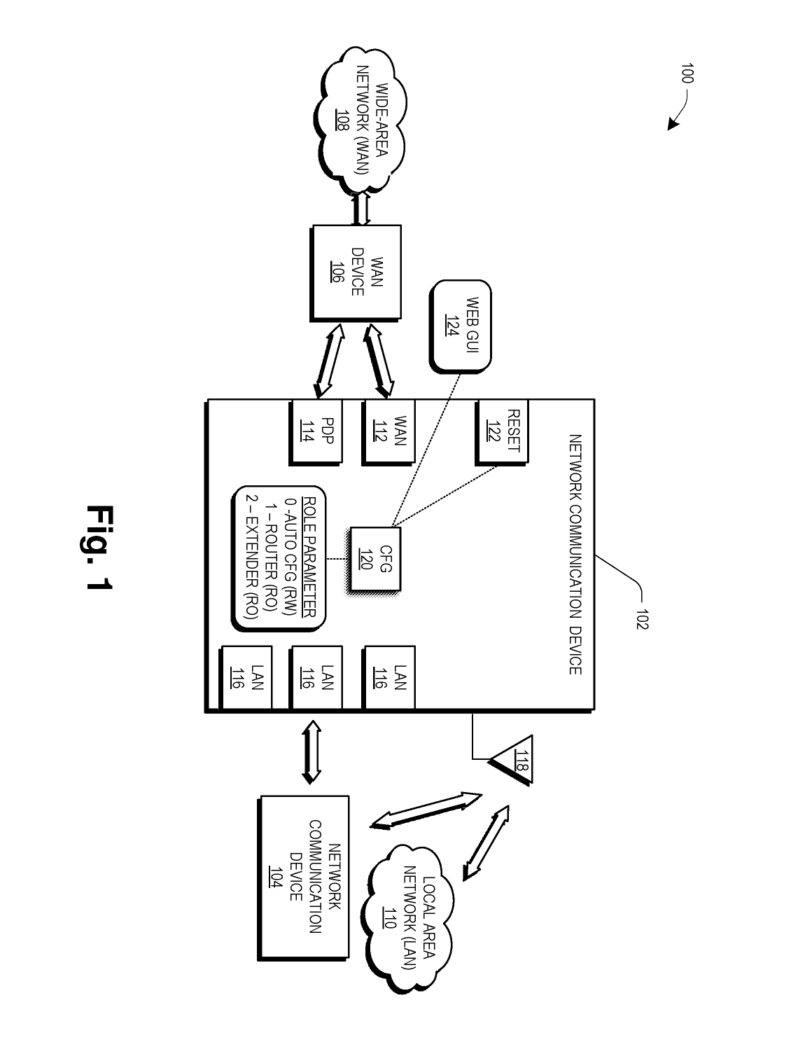

FIG. 1 is a diagram of a communication system 100, according to some embodiments. The communication system 100 comprises network communication devices 102, 104 interfacing with a wide-area network (WAN) device 106 and communicating between a wide-area network 108 and a local area network 110, such as an Ethernet network. In some embodiments, the network communication device 102, 104 includes various communication interfaces, such as a WAN port 112, a pluggable device port (PDP) 114, one or more wired LAN ports 116, and/or a wireless LAN interface 118. When used in the context of providing network services to premises, such network communications devices 102, 104 are sometimes called “gateways” or “premises gateways”, as they are used to provide an interface between one or more local networks at a premises and the WAN. They also typically include layer 3 (Internet Protocol) routing capabilities in order to forward IP traffic between local networks and the WAN. As such, these devices are also sometimes referred to as “home routers”, “broadband routers”, “gateway routers”, and the like.

In some embodiments, the WAN device 106 is an Optical Networking Unit (ONU) for PON communications, a cable modem for DOCSIS hybrid fiber-coax communications, a fixed wireless modem for cellular or other wide-area wireless data network communications, or an edge device providing carrier Ethernet. WAN device 106 may interface with the network communication device 102 via a connection (e.g., Ethernet) to the WAN port 112. In another embodiment, the WAN device 106 may be a small form factor pluggable (SFP+) device that interfaces with the network communication device via a pluggable connector using the PDP 114 (e.g., SFP, SFP+, or some other pluggable device interface). In some embodiments, a user may incorrectly connect the WAN device 106 via a connection (e.g., Ethernet) to a LAN port 116, and at least some of the subject matter disclosed herein mitigates at least some potential adverse effects thereof. The network communication devices 102, 104 may be deployed at a customer premises to provide connectivity to devices at the premises using the LAN 110. In some embodiments, the PDP 114 may support a Multimedia over Coax Alliance (MoCA) SFP device for providing additional LAN connectivity using a wired network topology communicating over coaxial cables.

In the illustrated embodiment, the network communication devices 102, 104 may be identical devices – they may include the same hardware and software components. However, the network communication device 102 is configured as a “router” for the LAN 110 and the network communication device 104 is configured as an “extender” for the LAN 110. The network communication device 104 may connect to the network communication device 102 using a wired connection between wired LAN ports 116 of the network communication devices 102, 104 or by using a wireless connection over the wireless LAN interfaces 118 implemented by the network communication devices 102, 104.

The network communication device 102 becomes configured as a router and the network communication device 104 becomes configured as anextender during an automatic initialization process. In some embodiments, the automatic initialization process determines a role of the network communication device 102, 104 based on a network environment determined by evaluating network connectivity on one or more communication interfaces of the network communication device 102, 104, sets a configuration parameter in a configuration (CFG) memory 120 of the network communication device 102, 104 based on the role, and completes the initialization process based on the assigned role.

As an example, in a router configuration, the network communication device 102 may provide one or more of: layer 2 switching of traffic between devices on the local network(s), wireless LAN access point capabilities, layer 3 (IP) routing, NAT and Port Forwarding capabilities; a DNS server to resolve and cache DNS requests from LAN devices, a DHCP server to assign addresses to devices that connect to the LAN 110, firewall and/or access control filtering for traffic to/from the LAN 110, and other traditional router or gateway functionalities. However, in an extender configuration, the network communication device 104 may be limited to providing layer 2 switching of traffic between devices connected to the LAN 110 and wireless LAN access point capabilities, without performing other functions for the LAN 110.

Automatically configuring the network communication devices 102, 104 obviates the need for a technician or other person with network knowledge at the customer premises and improves the customer experience. Also, the service provider can use a single physical device to provide router or extender functionality, simplifying inventory management and reducing cost.

In some embodiments, the role of the network communication device 102, 104 is determined by the value of a role parameter set in a configuration memory 120. A default role parameter value of “0” corresponds to a factory default state where the role is unassigned for the network communication device 102, 104 and the network communication device 102, 104 is in an “AUTO CFG” condition. In the examples described herein, a role parameter value of “1” corresponds to a router role, and a role parameter value of “2” corresponds to an extender role. In other implementations, different values may be assigned to represent these roles, and/or other roles may be specified. For example, in some embodiments a “switch” role may be included that only enables wired switching capabilities for a network communications device.

In some embodiments, a protection stage of the configuration memory 120 depends on the value of the role parameter. For the default (unassigned) role parameter value (“0” in the current example) the configuration memory 120 is configured to allow read/write (RW) access. For role parameter values of defined roles (“1” or “2” in the current example) the configuration memory 120 is configured to allow read only (RO) access. Protecting the configuration memory 120 ensures the configuration of the LAN 110 will be protected from inadvertent modification outside of the configuration process. In some embodiments, the value of the role parameter may be reset to the unassigned value by implementing a factory reset, such as be engaging a factory reset button 122. In some embodiments, if the role parameter is set to the default value and RW access to the configuration memory 120 is allowed, a service technician may manually change the role parameter in the configuration memory 120 using a web graphical user interface (GUI) 124. The WEB GUI 124 may also be used if the automatic configuration process results in a failure state.

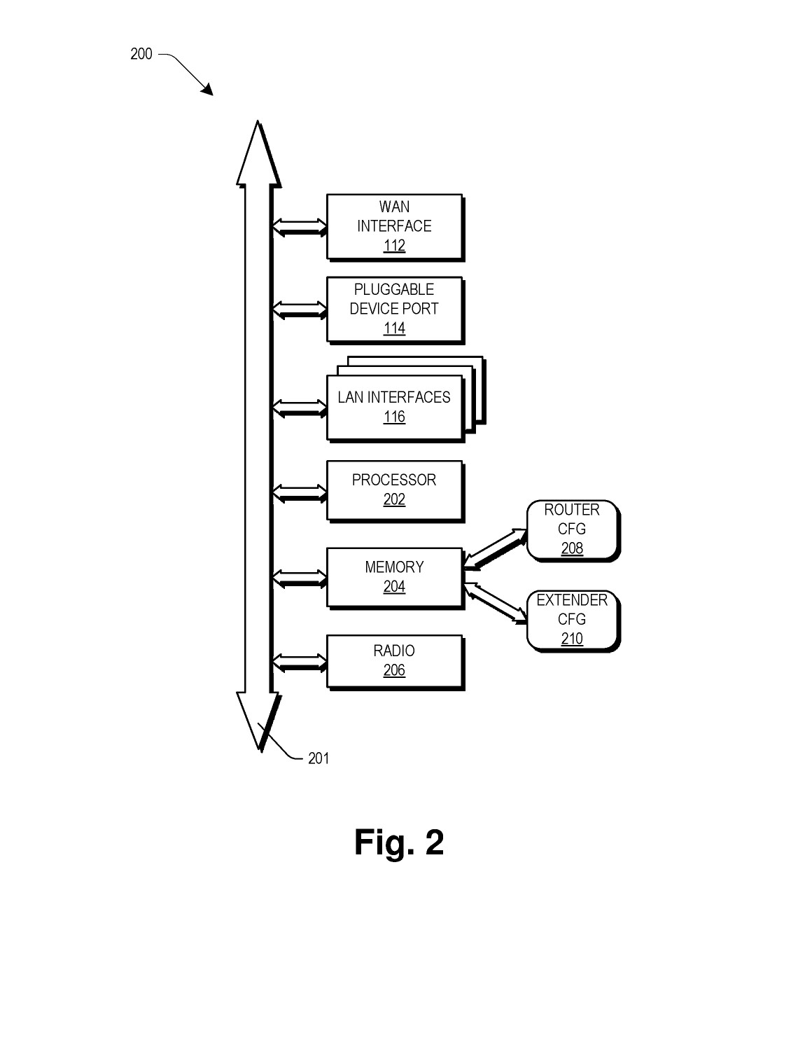

FIG. 2 is a diagram of a network communication device 200 (e.g., one of the network communication devices 102, 104 in FIG. 1), according to some embodiments. In some embodiments, the network communication device 200 comprises a bus 201, a processor 202, a memory 204 comprising the configuration memory 120, a radio 206 for implementing a wireless communication protocol over the wireless LAN interface 118, the WAN port 112, the PDP 114 (e.g., SFP, SFP+, or other pluggable device interface), and one or more wired LAN ports 116. The network communication device 200 may include fewer components, additional components, different components, and/or a different arrangement of components than those illustrated in FIG. 2.

According to some embodiments, the bus 201 include paths that permit communication among the components of the network communication device 200. For example, the bus 201 may include a system bus, an address bus, a data bus, and/or a control bus. The bus 201 may also include bus drivers, bus arbiters, bus interfaces, and so forth. The processor 202 may include one or multiple processors, microprocessors, data processors, co-processors, such as a mathematics coprocessor or an integrated graphical processing unit (GPU), one or more layers of local cache memory, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processor 202 may be implemented as hardware (e.g., a microprocessor, etc.), a combination of hardware and software (e.g., a SoC, an ASIC, etc.), may include one or multiple memories (e.g., cache, etc.), etc.

In some embodiments, the memory 204 includes one or multiple memories and/or one or multiple other types of storage mediums. For example, the memory 204 may include one or multiple types of memories, such as, random access memory (RAM), dynamic random access memory (DRAM), cache, read only memory (ROM), programmable read only memory (PROM), static random access memory (SRAM), flash memory, and/or some other suitable type of memory. The memory 204 may include a hard disk, a magnetic disk, an optical disk, a magneto-optic disk, a solid state disk, a Micro-Electromechanical System (MEMS)-based storage medium, a nanotechnology-based storage medium, and/or some other suitable memory. The memory 204 may be external to and/or removable, such as, for example, a Universal Serial Bus (USB) memory stick, a dongle, a hard disk, mass storage, off-line storage, or some other type of storing medium. The memory 204 may store data, software, and/or instructions.

In some embodiments, the memory 204 stores role configuration data, e.g., router configuration data 208 and extender configuration data 210. The router configuration data 208 and extender configuration data 210 may represent different software images or different sets of configuration parameters specific to the router role or the extender role. For example, the extender configuration data 210 may cause certain hardware and/or softwarecomponents of the network communication device to be disabled. The role configuration data may be stored as part of the device configuration process, more fully described elsewhere herein.

In some embodiments, the processor 202 controls the overall operation or a portion of the operation(s) of the network communication device 200. The processor 202 may perform one or multiple operations based on an operating system and/or various applications or computer programs (e.g., software).

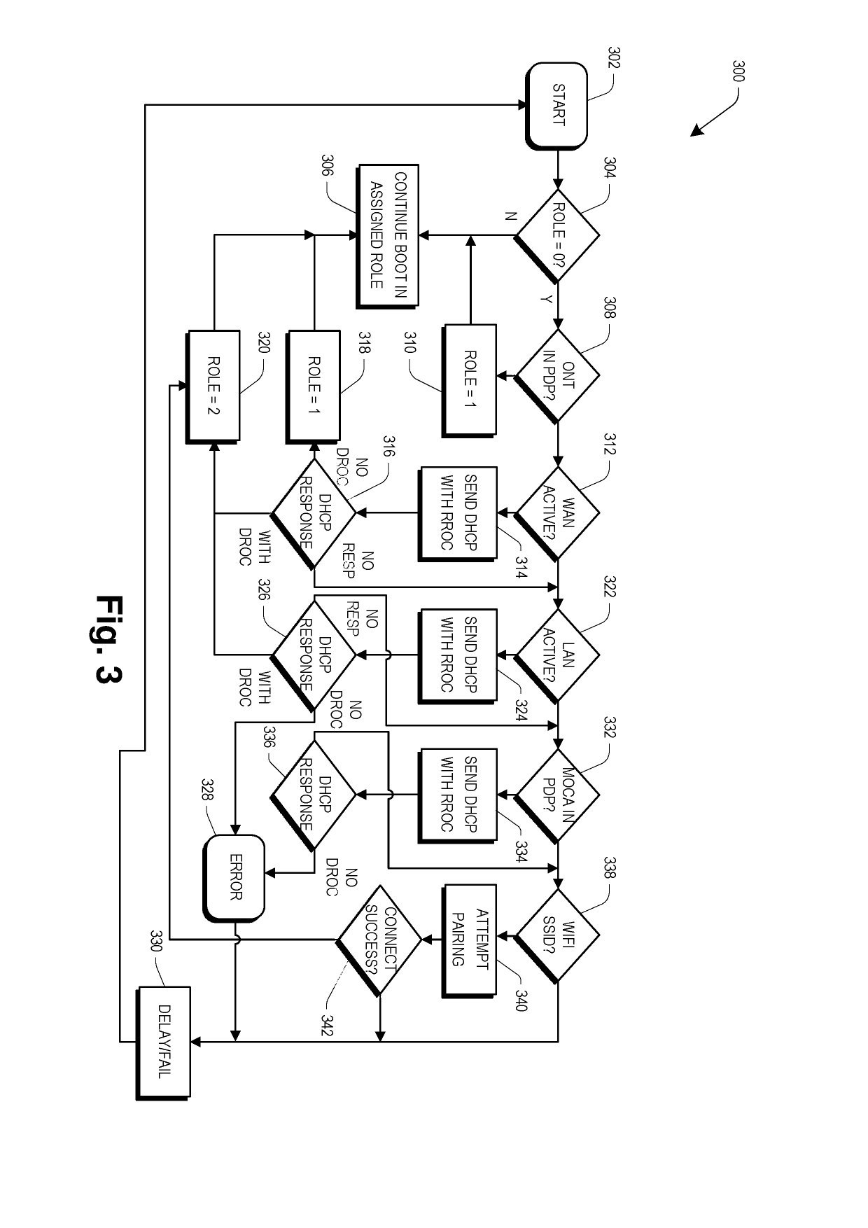

FIG. 3 is a flow diagram illustrating an example method 300 for configuring the network configuration device 200, according to some embodiments. The method 300 may be implemented by the processor 202 during a boot process. The method 300 starts at 302 to initialize the network communication device 200. If the role parameter is not the default/unassigned value (in this example “0”) at 304, the network communication device 200 continues the boot process at 306 according to the assigned role using the appropriate software image or set of stored role configuration data (e.g., router configuration data 208 if the role parameter is set to “router” or the extender configuration data 210 if the role parameter is set to “extender”). If the network communication device 200 is in auto configuration mode (e.g., role parameter = “0”) at 304, the processor 202, performs the auto configuration process.

Initially the process determines if an ONU is present connected to the PDP 114 and in an active state to provide WAN connectivity at 308. If an ONU is present and in an active state at 308, this indicates that the device is connected to an ONU, which means that the device must take the role of “router” as the gateway to the WAN 108. The role parameter is set to “1” indicating a router configuration at 310, stores router configuration data 308, and the network communication device 200 continues the boot process in the assigned role (e.g., router) at 306.

If the ONU is not active at 308, the processor 202 determines if the WAN port 112 is active at 312. If the WAN port 112 is in an active state at 312, the processor 202 sends a Dynamic Host Configuration Protocol (DHCP) request (e.g., an address request) to the upstream device connected to the WAN port 112 at 314. The DHCP request includes a role request option code (RROC) that is used to signal to the upstream device that the network communication device 200 is requesting a response that includes an indication of the role of the upstream device. For example, a role request option code of “60” may be specified with the DHCP request as the role request option code, to avoid conflict with other known DHCP option codes. An upstream device with automatic role determination capability would respond to a request specifying the role request option code (in this case “60”) with a response specifying a designated role option code (DROC), such as option code “43”, “125”, or some other code representing its role as a “router”.

The processor 202 identifies a DHCP response at 316. If the DHCP response does not include a DROC (e.g., no option code “43” or “125” specified), the device may assume that the upstream device is providing WAN connectivity, and therefore the network communication device 200 should act as the gateway to the WAN 108. The processor 202 sets the role parameter to “1” indicating a router configuration at 318, stores the router configuration data, and the network communication device 200 continues the boot process in the assigned role (e.g., router) at 306.

If a DHCP response specifying a DROC is received at 316, and the DROC indicates that the upstream device has the role “router” (in this example, option code “43” or “125”), this is interpreted to mean that the device should not operate as a router, but instead operate in “extender” mode. The processor 202 sets the role parameter to “2” indicating an extender configuration at 320, stores the extender configuration data, and the network communication device 200 continues the boot process in the assigned role (e.g., extender) at 306.

If no DHCP response is received within a timeout period at 316, the processor 202 next determines if one of the wired LAN ports 116 is in an active state at 322. If a wired LAN port 116 is in an active state at 322, the processor 202 sends a DHCP request at 324. The DHCP request includes a RROC (in this case “60”). The processor 202 identifies a DHCP response at 326. If the DHCP response does not include a DROC (e.g., no option code "43” or “125” specified), the device may assume that the upstream device is providing WAN connectivity, and therefore the network communication device 200 should act as the gateway to the WAN 108. The processor 202 sets the role parameter to “2” indicating an extender configuration at 320 and the network communication device 200 stores the role configuration data, and the network communication device 200 continues the boot process in the assigned role (e.g., extender) at 306. Again, additional security measures may be implemented to authenticate the network communication device 200. Checking the LAN port 116 allows the network communication device 200 to be configured even if the customer mistakenly connects the WAN device to the LAN port 116 instead of the WAN port 112, thereby improving the user experience by being tolerant of the connection error.

If the DHCP response received at 326 does not include a DROC (e.g., no option code “43” or “125” specified) is received at 326, the processor 202 transitions to an error state at 328. After being in a delay state at 330 for a predetermined time period, the processor 202 returns to 302 and restarts the boot process. The delay allows a user to reconnect a WAN device if it had been previously connected incorrectly. An indicator on the network communication device 200 may indicate the error state.

The method 300 may iterate steps 322, 324, 326 for each of the LAN ports 116.

If no DHCP response is received at 326 (e.g., after iterating for each of the LAN ports 116 and after a timeout period has elapsed), the processor 202 determines if a MoCA device is active in the PDP 114 at 332. If the MoCA device is active at 332, the processor 202 sends a DHCP request at 334. The DHCP request includes an RROC (in this example, “60”). The processor 202 identifies a DHCP response at 336. If the DHCP response includes a DROC (e.g., option code “43” or “125”) indicating that a parent device associated with the service provider is configured as a router is providing connectivity through the PDP 114, the processor 202 sets the role parameter to “2” indicating an extender configuration at 320, stores the role configuration data, and the network communication device 200 continues the boot process in the assigned role (e.g., extender) at 306. Again, additional security measures may be implemented to authenticate the proprietary device.

If the DHCP response received at 336 does not include a DROC (e.g., no option code “43” or “125” specified), the processor 202 transitions to the error state at 328. After being in a delay state at 330 for a predetermined time period, the processor 202 returns to 302 and restarts the boot process. The delay allows a user to reconnect a WAN device if it had been previously connected incorrectly. An indicator on the network communication device 200 may indicate the error state. If the delay state is reached a predetermined number of times, the method 300 may terminate in a fault state.

If no DHCP response is received at 336 within a timeout period, the processor 202 determines if a Wi-Fi network with a visible Service Set Identifier (SSID) is available at 338. In this situation, no devices are identified on the wired communication interfaces of the network communication device 200 (e.g., the WAN port 112, the PDP 114, or the LAN ports 116). At 338, the processor 202 checks for wireless connectivity after exhausting the wired communication interfaces. If a Wi-Fi network with a visible Service Set Identifier (SSID) is available at 338, the processor 202 attempts to pair with the WiFi network at 340. If a connection is successful at 342, the processor 202 sets the role parameter to “2” indicating an extender configuration at 320 and the network communication device 200 continues the boot process in the assigned role (e.g., extender) at 306. In some embodiments, the paring may be conducted using a Wi-Fi Protected Setup (WPS) protocol where a user presses a paring button on the network communication device 200 and on the device acting as a router, using a Device Provisioning Protocol (DPP) where the user scans a QR code with an encoded public key, or by providing WiFi paring credentials to the network communication device 200 though backend communication from the service provider. If a connection is not successful at 342, the processor 202 transitions to the delay/fail state at 300 indicating a failure state. If the delay and restart is repeated for a predetermined number of times, a failure state may be indicated. In some embodiments, the indicator on the network communication device 200 may have a different color or blinking pattern to distinguish between a delay state and a failure state.

In some embodiments, after the failure state has been reached the role parameter to “1” or “2” may be manually changed in the configuration memory 120 using the web graphical user interface (GUI) 124.In some embodiments, additional security measures may be implemented to authenticate the network communication device 200 being configured. For example, backend communication using a public key of the network communication device 200 being configured may be sent with the DHCP request and the parent network communication device 200 (e.g., the router) may communicate with a service provider or may have a memory configured with allowed devices on the account associated with the customer premises to authenticate the public key prior to sending the DHCP response. In this manner, the network communication device 200 will not connect to a device associated with a different account.

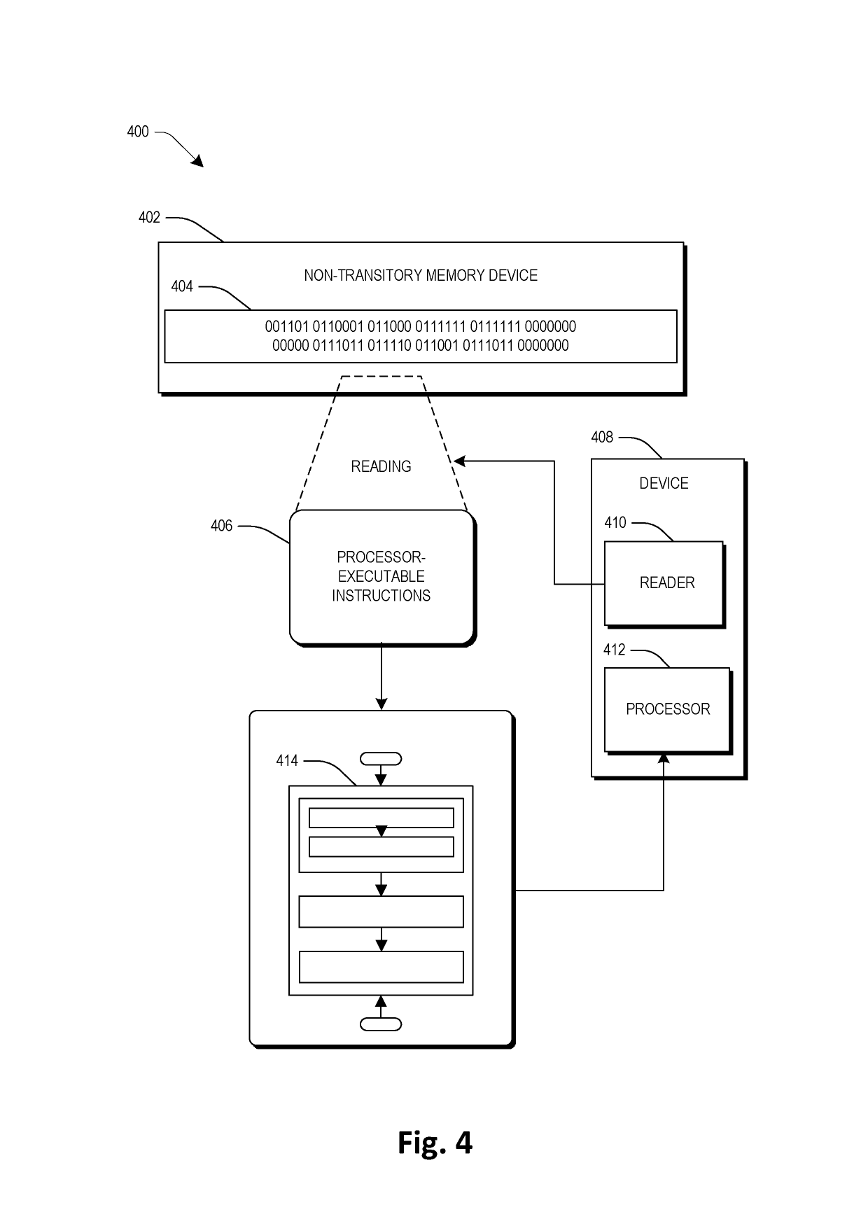

FIG. 4 is an illustration of a scenario 400 involving an example non-transitory machine-readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor device (e.g., a semiconductor device utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 402 stores machine-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method of FIG. 3, for example. In some embodiments, the processor-executable instructions 412 are configured to cause implementation of a system.

Automatically configuring the roles of the network communication devices 102, 104 simplifies installation at the customer premises and improves the accuracy of the applied configuration. Another advantage of the automatically configurable network communication device 200 is that in the event of a device failure of a network communication device 200 configured as a router, a factory reset may be performed on a different network communication device 200 at the customer premises causing the reset device to perform an automatic configuration and allow it to assume the role of a router. Hence, the LAN 110 remains operational until additional equipment can be provided to replace the failed network communication device 200. Using the same network communication device 200 to provide router or extender functionality can also reduce costs for the service provider.

As used in this application, "component," "module," "system", "interface", and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, "example" is used herein to mean serving as an example, instance, illustration, etc., and not necessarily as advantageous. As used herein, "or" is intended to mean an inclusive "or" rather than an exclusive "or". In addition, "a" and "an" as used in this application are generally be construed to mean "one or more" unless specified otherwise or clear from context to be directed to a singular form. Also, at least one of A and B and/or the like generally means A or B or both A and B. Furthermore, to the extent that "includes", "having", "has", "with", and/or variants thereof are used in either the detailed description or the claims, such terms are intended to be inclusive in a manner similar to the term "comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
executing an initialization process of a network communication device;
evaluating a role parameter associated with the network communication device; and
responsive to the role parameter corresponding to an automatic configuration condition:
evaluating network connectivity on a communication interface of the network communication device;
assigning a role to the network communication device based on the network connectivity; and
configuring the network communication device according to the role during the initialization process.

2. The method of claim 1, comprising:
storing a default value of the role parameter in a configuration memory of the network communication device indicating the automatic configuration condition according to an unassigned role;
modifying the role parameter based on the role; and
assigning a read only state to the configuration memory after modifying the role parameter.

3. The method of claim 2, comprising:
responsive to a factory reset of the network communication device:
resetting the role parameter to the default value; and
assigning a read/write state to the configuration memory after resetting the role parameter.

4. The method of claim 1, wherein:
the communication interface comprises a pluggable device port;
evaluating the network connectivity comprises:
identifying a wideband device active on the pluggable device port; and
assigning the role to the network communication device comprises:
assigning a router role to the network communication device.

5. The method of claim 1, wherein:
evaluating the network connectivity comprises:
sending an address request comprising a role request option code over the communication interface; and
receiving an address response over the communication interface; and
assigning the role to the network communication device comprises:
assigning an extender role to the network communication device responsive to the address response comprising a designated role option code corresponding to the role request option code; and
assigning a router role to the network communication device responsive to the address response not comprising the designated role option code corresponding to the role request option code.

6. The method of claim 5, comprising:
responsive to not receiving the address response:
identifying an active state of a pluggable device port indicating a coaxial communication device connected to the pluggable device port;
sending a second address request comprising a second role request option code over the pluggable device port;
receiving a second address response over the pluggable device port; and
assigning a second extender role to the network communication device responsive to the second address response comprising a second designated role option code corresponding to the second role request option code.

7. The method of claim 1, wherein:
evaluating the network connectivity comprises:
responsive to failing to identify an active state of the communication interface, identifying a presence of a wireless network at a wireless interface of the network communication device; and
assigning the role to the network communication device comprises:
assigning an extender role to the network communication device responsive to successfully establishing a connection over the wireless interface.

8. The method of claim 1, comprising:
responsive to identifying an error condition associated with evaluating the network connectivity, restarting the initialization process.

9. A network communication device, comprising:
a memory configured to store a role parameter;
a communication interface; and
a processor configured to
execute an initialization process; and
responsive to the role parameter corresponding to an automatic configuration condition:
evaluate network connectivity on the communication interface;
assign a role to the network communication device based on the network connectivity; and
configure the network communication device during the initialization process according to the role.

10. The network communication device of claim 9, wherein:
a default value of the role parameter indicates the automatic configuration condition according to an unassigned role; and
the processor is configured to:
modify the role parameter based on the role; and
assign a read only state to the role parameter in the memory after modifying the role parameter.

11. The network communication device of claim 10, wherein the processor is configured to:
responsive to a factory reset of the network communication device:
reset the role parameter to the default value; and
assign a read/write state to the role parameter in the memory after resetting the role parameter.

12. The network communication device of claim 9, wherein:
the communication interface comprises a pluggable device port; and
the processor is configured to:
evaluate the network connectivity by:
identifying a wideband device active on the pluggable device port; and
assign the role to the network communication device by:
assigning a router role to the network communication device.

13. The network communication device of claim 9, wherein:
the processor is configured to:
evaluate the network connectivity by:
sending an address request comprising a role request option code over the communication interface; and
receiving an address response over the communication interface; and
assign the role to the network communication device by:
assigning an extender role to the network communication device responsive to the address response comprising a designated role option code corresponding to the role request option code; and
assigning a router role to the network communication device responsive to the address response not comprising the designated role option code corresponding to the role request option code.

14. The network communication device of claim 13, wherein:
the processor is configured to:
responsive to not receiving the address response:
identify an active state of a pluggable device port indicating a coaxial communication device connected to the pluggable device port;
send a second address request comprising a second role request option code over the pluggable device port;
receive a second address response over the pluggable device port; and
assign a second extender role to the network communication device responsive to the second address response comprising a second designated role option code corresponding to the second role request option code.

15. The network communication device of claim 9, wherein:
the processor is configured to:
responsive to failing to identify an active state of the communication interface:
identify a presence of a wireless network at a wireless interface of the network communication device; and
assign an extender role to the network communication device responsive to successfully establishing a connection over the wireless interface.

16. The network communication device of claim 9, wherein:
the processor is configured to:
responsive to identifying an error condition associated with evaluating the network connectivity, restarting the initialization process.

17. A method, comprising:
executing a first initialization process of a first network communication device configurable according to a router role or an extender role;
responsive to a first role parameter associated with the first network communication device indicating an unassigned role;
evaluating first network connectivity of a first communication interface of the first network communication device;
changing the first role parameter to assign the router role to the first network communication device based on the first network connectivity; and
configuring the first network communication device according to the router role during the first initialization process;
executing a second initialization process of a second network communication device configurable according to the router role or the extender role; and
responsive to a second role parameter associated with the second network communication device indicating an unassigned role;
evaluating second network connectivity of a second communication interface of the second network communication device with the first network communication device;
changing the second role parameter to assign the extender role to the second network communication device based on the second network connectivity; and
configuring the second network communication device according to the extender role during the second initialization process.

18. The method of claim 17, wherein:
evaluating the first network connectivity of the first communication interface of the first network communication device comprises:
identifying a presence of a wide band device on the first communication interface.

19. The method of claim 17, wherein:
evaluating the second network connectivity of the second communication interface of the second network communication device with the first network communication device comprises:
sending an address request comprising a role request option code over the second communication interface;
receiving an address response from the first network communication device over the second communication interface; and
assigning the extender role to the second network communication device responsive to the address response comprising a designated role option code corresponding to the role request option code.

20. The method of claim 17, comprising:
factory resetting the second network device to reset the second role parameter to indicate the unassigned role;
executing a third initialization process of the second network communication device; and
responsive to the second role parameter indicating the unassigned role;
evaluating network connectivity of the second communication interface;
changing the second role parameter to assign the router role to the second network communication device based on the network connectivity; and
configuring the second network communication device according to the router role during the third initialization process.
